(19) United States
(12) Patent Application Publication
(10) Pub. No.: US 2013/0283023 A1
(43) Pub. Date: Oct. 24, 2013

(54) Bimodal Compare Predictor Encoded In Each Compare Instruction

(71) Applicants: Charles Joseph Tabony, Austin, TX (US); Lucian Codrescu, Austin, TX (US); Suresh K. Venkumahanti, Austin, TX (US)

(72) Inventors: Charles Joseph Tabony, Austin, TX (US); Lucian Codrescu, Austin, TX (US); Suresh K. Venkumahanti, Austin, TX (US)

(73) Assignee: QUALCOMM INCORPORATED, San Diego, CA (US)

(21) Appl. No.: 13/449,754

(22) Filed: Apr. 18, 2012

(51) Int. Cl. G06F 9/30

(52) U.S. Cl. 712/240; 712/E09.028

(57) ABSTRACT

Systems and methods for branch prediction, including predicting evaluation of a producer instruction such as a compare instruction, by encoding a prediction field in the producer instruction, and predicting evaluation of the producer instruction by using the encoded prediction field. A consumer instruction such as a conditional branch instruction predicated on the producer instruction can be speculatively executed based on the predicted evaluation of the producer instruction. The producer instruction is executed in an execution pipeline to determine an actual evaluation of the producer instruction, and the prediction field is updated, if necessary, based on the actual evaluation and the predicted evaluation. The producer instruction can be updated in memory with the updated prediction field.

### FIELD OF DISCLOSURE

Disclosed embodiments relate to branch prediction mechanisms. More particularly, exemplary embodiments are directed to techniques for predicting outcome of instructions, such as compare instructions, and further, encoding the predictions in the instructions.

### BACKGROUND

Branch prediction mechanisms are conventionally employed in computer processors to predict the direction of branches. The direction taken by a branch, such as a conditional branch, may depend on the evaluation of a condition to true or false. For example, a branch instruction may resemble the form, “if <condition_{—}1> jump,” wherein, if condition_{—}1 evaluates to true, the operational flow may jump to executing instructions at a new location indicated by a target address specified by the instruction (this scenario is also referred to as the branch being “taken”). If condition_{—}1 evaluates to false, then the operational flow may continue to execute the next sequential instruction after the branch instruction (this scenario is also referred to as the branch being “not-taken”).

In order to improve instruction level parallelism (ILP), processors may implement branch prediction mechanisms to predict whether the branch will be taken or not taken before the branch instruction is encountered. In this manner, the conditional branch instruction may be scheduled to execute prior to resolution of the condition, condition_{—}1. If the prediction turns out to be false, conventionally used correction mechanisms may include flushing the instructions which were wrongly executed based on the incorrect branch prediction and replaying the instructions in the correct path.

With regard to predicting the outcome of the above conditional branch instruction, several approaches are known in the art. In a first approach, a history of evaluation of the conditional branch instruction itself may be studied, and predictions of taken or not-taken may be made based on the history. The success of this first approach relies on the same conditional branch instruction being evaluated the same way, without focusing on the underlying condition.

A second approach includes the use of predicate registers. The semantics of a predicated branch instruction may resemble the form: “if <predicate_{—}1> jump.” In such predicated branch instructions, the value of the predicate register, predicate_{—}1, would control the direction of the conditional branch between taken and not-taken. Thus, the same predicate register may be used for predicting the direction of several branch instructions, in contrast to the first approach. Moreover, the predicate register may also be employed in conditional instructions that are not branch instructions.

Processors which adopt the use of predicate registers may include instructions to generate the values for the predicate registers, referred to herein as “producer instructions.” The one or more instructions, such as conditional branch instructions, which employ the predicate registers are referred to herein as “consumer instructions.” The consumer instructions are said to be predicated on the producer instructions. Generally, producer instructions which involve a comparison of two operands or values, such as “greater than,” “less than,” “equal to” or combinations thereof, may be used to write or set the predicate registers. An example producer instruction may take the form, “predicate_{—}1=compare (A, B),” wherein the result of a comparison operation of operands A and B will set the predicate register, predicate_{—}1. Thereafter, the value of predicate_{—}1 may control the direction of a consumer instruction, such as the conditional branch described above.

The second approach also suffers from some drawbacks. For example, the correct use of predicate registers requires that they are appropriately updated. In other words, the producer instruction, such as the compare instruction must be fully evaluated, and the corresponding predicate register must be set before any following consumer instruction may be allowed to execute. This creates a bottleneck because implementing logic for performing compare operations may involve significant latency. Moreover, waiting for the producer instruction to fully evaluate and write to the predicate register before allowing the consumer instructions to execute, imposes serialization, thus destroying parallelism.

Accordingly, there is a corresponding need in the art to overcome the drawbacks of the aforementioned approaches related to prediction mechanisms.

### SUMMARY

Exemplary embodiments of the invention are directed to systems and methods for branch prediction. More particularly, exemplary embodiments are directed to techniques for predicting outcome of a producer instruction, such as a compare instruction, and encoding the predictions in prediction fields of the producer instruction. A consumer instruction such as a conditional branch instruction predicated on the producer instruction may be speculatively executed based on the predicted evaluation of the producer instruction based on the prediction field.

For example, an exemplary embodiment is directed to a method of predicting evaluation of a producer instruction comprising: encoding a prediction field in the producer instruction; and predicting evaluation of the producer instruction, in a processor, using the prediction field.

Another exemplary embodiment is directed to processing system comprising: a memory; a producer instruction stored in the memory, the producer instruction comprising a prediction field; and logic configured to predict evaluation of the producer instruction using the prediction field.

Yet another exemplary embodiment is directed to a processing system comprising: a producer instruction stored in a storage means, the producer instruction comprising a prediction field; and means for predicting evaluation of the producer instruction using the prediction field.

Another exemplary embodiment is directed to a non-transitory computer-readable storage medium comprising code, which, when executed by a processor, causes the processor to perform operations for predicting evaluation of a producer instruction, the non-transitory computer-readable storage medium comprising: code for encoding a prediction field in the producer instruction; and code for predicting evaluation of the producer instruction, in a processor, using the prediction field.

### BRIEF DESCRIPTION OF THE DRAWINGS

The accompanying drawings are presented to aid in the description of embodiments of the invention and are provided solely for illustration of the embodiments and not limitation thereof.

FIG. 1 is a simplified schematic representation of hardware configured according to exemplary embodiments for predicting evaluation of a producer instruction.

FIG. 2 illustrates an operation flow for transitioning between bimodal prediction states in an exemplary producer instruction.

FIG. 3 illustrates an operational flow for a method of predicting evaluation of a producer instruction according to exemplary embodiments.

FIG. 4 illustrates an exemplary wireless communication system 400 in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments are directed to improving efficiency and performance of prediction mechanisms. More specifically, embodiments are configured to expedite and lower costs of implementing prediction for producer instructions, such as compare instructions. Moreover, embodiments allow convenient reuse of the same prediction mechanisms in a single producer instruction for multiple consumer instructions, such as conditional instructions, and more particularly, consumer branch instructions.

In an exemplary embodiment, a producer instruction, such as a compare instruction is configured to include a field for storing prediction information within the producer instruction itself, such that when the producer instruction is read out, the corresponding prediction information may be used to predict evaluation of the producer instruction. Moreover, embodiments allow the prediction information to include one or more prediction state bits to represent a strength or confidence level in the prediction. The prediction state bits may be updated once the actual resolution of the producer instruction is known deep in the pipeline. Prediction logic may be configured to generate a prediction of evaluation of the producer instruction as true or false based on the prediction state bits and other information. For example, the prediction logic may also take into account, other information such as, a history of evaluation of the producer instruction.

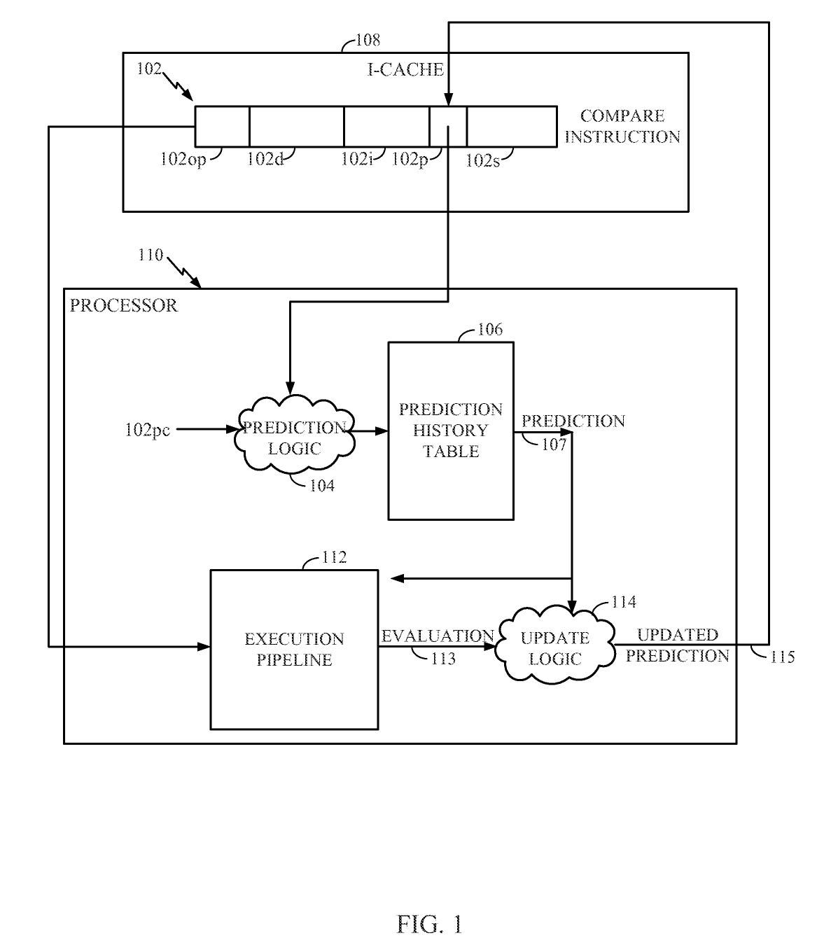

With reference now to FIG. 1, a simplified schematic representation of processor 110 coupled to instruction cache 108 is illustrated. Processor 110 may be configured to receive instructions from instruction cache 108 and execute the instructions using for example, execution pipeline 112. Execution pipeline 112 may be configured as a conventional pipelined architecture and may include one or more pipelined stages for performing instruction fetch, decode, and execute operations. However, it will be understood that embodiments do not require execution pipeline 112 to be implemented as a staged pipeline, and any suitable combinational logic may be employed therein. Processor 110 may also be coupled to numerous other components (such as data caches, IO devices, memory, etc) which have not been explicitly shown, but are assumed to be understood by a person of ordinary skill in the art. Instruction cache 108 is shown to comprise a producer instruction, compare instruction 102, which will be described below in greater detail. However, exemplary embodiments are not limited to the illustrated structure, and the features of compare instruction 102 may be easily extended to any processing structure configured to execute compare instruction 102.

In an exemplary implementation, compare instruction 102 may have a corresponding address or program counter (PC) value of 102pc. Further, as shown, compare instruction 102 may comprise several fields, some of which may correspond to conventional instruction formats. For example, field 102op may represent the operation code (commonly known as “op-code”) which comprises encodings for specific operations (e.g. greater than, less than, equal to, etc.). Field 102s may correspond to a source register; field 102i may include an immediate value; and field 102d may correspond to a destination register. Deviating now from conventional instruction formats, compare instruction 102 may include prediction field 102p representing a prediction state in exemplary embodiments.

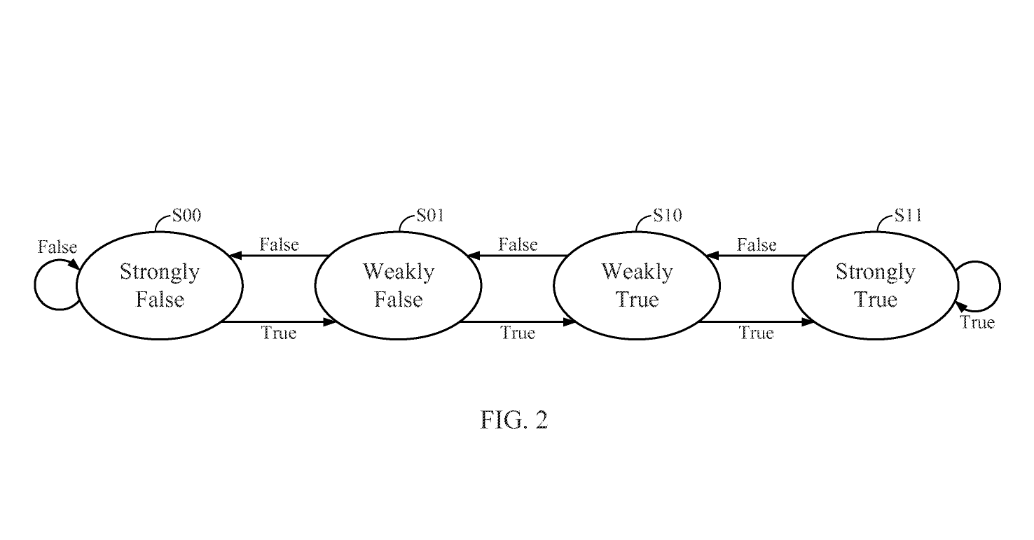

In one implementation, prediction field 102p may be a single-bit field which may encode the two prediction states, true and false, in one example, the “true” state may correspond to a consumer conditional branch instruction predicated on the producer instruction to be predicted as “taken,” and a “false” state may correspond to a prediction of “not-taken.” In other implementations, (as will be further described below with reference to FIG. 2) prediction field 102p may include two bits which may encode four prediction states, “strongly false,” “weakly false,” “weakly true,” and “strongly true” (corresponding likewise to predictions of a consumer conditional branch instruction to “strongly not-taken,” “weakly not-taken,” “weakly taken,” and “strongly taken”). Such a two-bit implementation of prediction field 102p will be referred to herein as a “bimodal” encoding.

With continuing reference to FIG. 1, processor 110 includes prediction logic 104 and prediction history table 106. Prediction history table 106 may comprise a history of behavior of prior producer instructions that traversed through the pipeline of processor 110. The behavior may include prediction and/or evaluation of the prior producer instruction. This history may be used to predict future evaluations of producer instructions as follows.

Prediction logic 104 may have one input as compare instruction 102. The address or PC value, 102pc may also be an input to prediction logic 104. Other information as appropriate may also be input to prediction logic 104. Prediction logic 104 may be configured to extract the relevant information from compare instruction 102, such as prediction states in prediction field 102p. Prediction logic 104 may then correlate the PC value from field 102pc and other information with the prediction state represented by prediction field 102p to index into prediction history table 106. The correlating and indexing may be performed, for example, by logic implementing a hash or XOR functions on the PC value and prediction states. Thereafter, the value stored in the indexed location of prediction history table 106 may be read out as prediction 107, which represents the predicted evaluation of compare instruction 102.

Some embodiments may avoid the use of prediction logic 104 and prediction history table 106, and directly derive prediction 107 of compare instruction 102 from the prediction state bits stored in prediction field 102p. While such implementations are less expensive than the above-described embodiments with prediction logic 104 and prediction history table 106, they may suffer from decreased accuracy of predictions. Skilled persons will recognize suitable implementations for predicting producer instructions, based on a desired tradeoff between accuracy and costs.

As illustrated in FIG. 1, this prediction 107 may be an input to execution pipeline 112. Using prediction 107, a consumer instruction of compare instruction 102, such as a conditional branch instruction may be speculatively executed, without waiting for compare instruction 102 to complete execution. In some embodiments, while prediction 107 of compare instruction 102 is being obtained for example through prediction logic 104 and prediction history table 106, the execution of compare instruction 102 may be performed in parallel (or suitably staggered based on particular implementations) in execution pipeline 112. Once the actual evaluation of compare instruction 102 is obtained after traversing the various stages of execution pipeline 112, evaluation may be output from execution pipeline 112 as evaluation 113. Update logic 114 may be provided to accept evaluation 113 as one input and prediction 107 as another input to see if the prediction and actual evaluation match. If there is a mismatch, then update logic may send out the updated prediction with the actual evaluation on the output line, updated prediction 115. This updated prediction 115 may then be used to update the prediction field 102p of compare instruction 102 stored in instruction cache 108.

Turning now to FIG. 2, a method for implementing prediction field 102p as a bimodal prediction state, and transitioning between such bimodal prediction states, is illustrated. As shown, two prediction state bits may encode four prediction states, S00: strongly false; S01: weakly false; S10: weakly true; and S11: strongly true. When a producer instruction, such as compare instruction 102 is first encountered (e.g. fetched by processor 110 for execution), the prediction state bits may be initialized to S00: strongly false. Once the producer instruction evaluates down the pipeline, and the evaluation was indeed false, then the prediction state bits remain at S00: strongly false. However, if the evaluation turned out to be true, then the prediction state bits may transition to S01: weakly false. From a prediction of S01: weakly false, an evaluation to true will lead to S10: weakly true; and an evaluation to false will lead back to S00: strongly false. Similarly, from S10: weakly true, an evaluation to true will lead to S11: strongly true; and an evaluation to false will lead to S01: weakly false. Finally, from S11: strongly true, an evaluation to true will keep the state in S11: strongly true; while an evaluation to false will lead back to S10: weakly true.

Thus, a bimodal predictor has a buffer for anomalies. In other words, if a particular producer instruction has a tendency to evaluate to true, then a single anomalous false evaluation will not alter the prediction to false. In comparison if a single bit prediction state were employed for the producer instruction with a tendency to evaluate to true, a single anomalous false evaluation would toggle the prediction to false, and thus destroy the indication of the tendency to evaluate to true.

The above-described operational flow for bimodal prediction may be implemented in logic using a two-bit saturating up-down counter. The counter may count up for each evaluation of true and count down for each evaluation of false. While counting up, if the count value reaches the upper extreme value “11” (corresponding to state S11: strongly true), the counter will saturate and remain at this state until a false evaluation causes the counter to count down. Similarly, while counting down, if the count value reaches the lower extreme value “00” (corresponding to state S00: strongly false), the counter will saturate and remain in this state until a true evaluation causes the counter to count up.

Thus, embodiments may embed a prediction field, such as a bimodal prediction field, within a producer instruction, and thereby predict the evaluation of the producer instruction, rather than predict the evaluation of a corresponding consumer instruction. In certain embodiments, embedding a prediction field in a producer instruction may not incur additional costs. For example, compare instruction 102 may have unused or reserved bits, which may be used to store prediction field 102p comprising bimodal prediction states. When compare instruction 102 is first encountered, it is loaded from instruction cache 108 (or from memory if it is not present in instruction cache 108), and executed for example in execution pipeline 112 in processor 110 to obtain the evaluation. Using update logic 114 and updated prediction 115, compare instruction 102 with the updated prediction field 102p may be stored back in instruction cache 108 or memory. The next time compare instruction 102 is encountered, the updated prediction field 102p is consulted to make prediction 107 (e.g. using prediction logic 104 and prediction history table 106). A consumer instruction of compare instruction 102p, such as a conditional branch instruction is then speculatively executed, for example, in execution pipeline 112 using prediction 107, without waiting for compare instruction 102 to complete execution in execution pipeline 112. Once compare instruction 102 completes execution in execution pipeline 112, prediction field 102p may be updated if necessary using update logic 114 as previously described. It will be understood that the consumer conditional branch instruction may need to be replayed if prediction 107 did not match evaluation 113, and updated prediction 115 is used to update prediction field 102p in compare instruction 102 at its storage location, for example, instruction cache 108.

Additionally, it will also be understood that in exemplary embodiments, prediction logic 104 and prediction history table 106 may be reused by multiple producer instructions without any need to replicate such hardware. Accordingly, embodiments comprise low-cost solutions for accurate prediction of individual producer instructions. Moreover, as previously described, several consumer instructions may be predicated on a single producer instruction. Thus, one or more consumer instructions predicated on a single producer instruction may be speculatively scheduled in parallel to exploit ILP, without waiting for the producer instruction to complete execution.

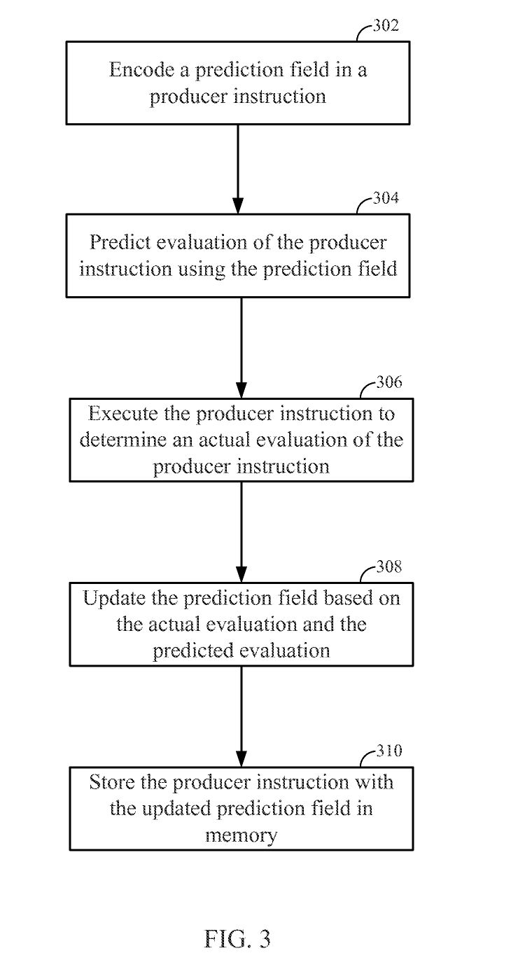

It will be appreciated that embodiments include various methods for performing the processes, functions and/or algorithms disclosed herein. For example, as illustrated in FIG. 3, an embodiment can include a method of predicting evaluation of a producer instruction (e.g. compare instruction 102) comprising: encoding a prediction field (e.g. prediction field 102p) in the producer instruction—Block 302; and predicting evaluation (e.g. prediction 107) of the producer instruction using the prediction field (e.g. using prediction logic 104 and prediction history table 106)—Block 304. The method can further include executing the producer instruction (e.g. in execution pipeline 112) to determine an actual evaluation (e.g. evaluation 113) of the producer instruction—Block 306; updating the prediction field based on the actual evaluation and the predicted evaluation (e.g. using update logic 114 to obtain updated prediction 115)—Block 308; and storing the producer instruction with the updated prediction field in memory—Block 310. The embodiments may then speculatively execute a consumer instruction (e.g. a conditional branch instruction) predicated on the producer instruction, using the predicted evaluation of the producer instruction based on the prediction field.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

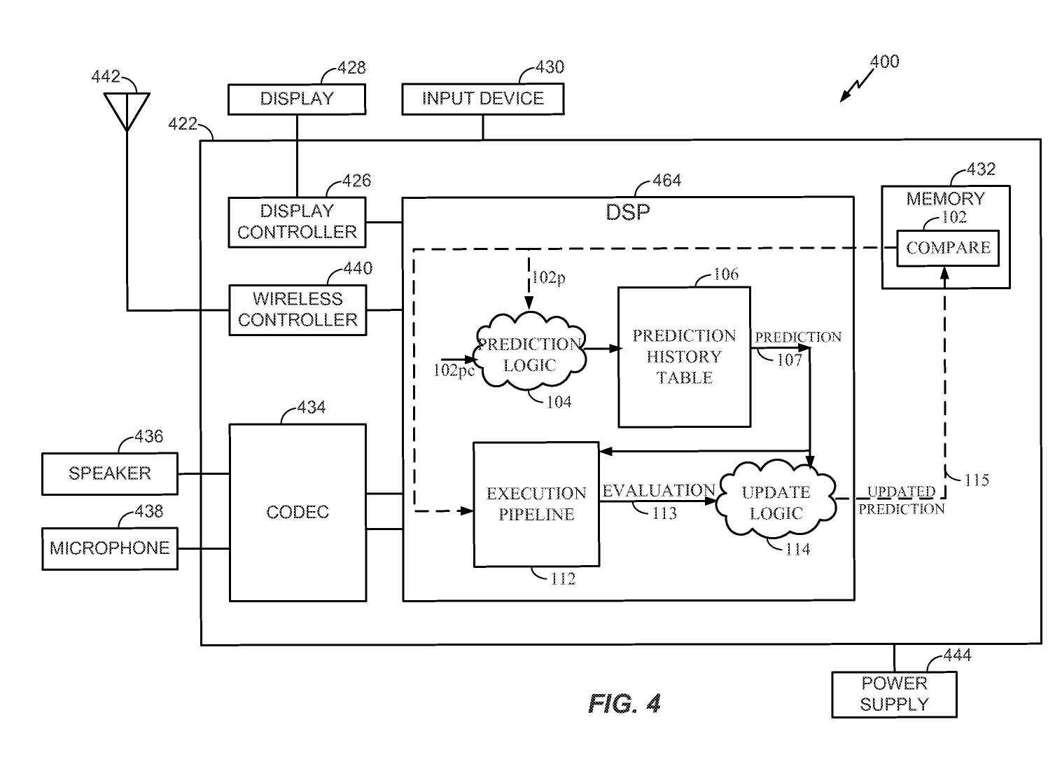

Referring to FIG. 4, a block diagram of a particular illustrative embodiment of a wireless device that includes a multi-core processor configured according to exemplary embodiments is depicted and generally designated 400. The device 400 includes a digital signal processor (DSP) 464 which may include components such as prediction logic 104, prediction history table 106, execution pipeline 112, and update logic 114 of FIG. 1. DSP 464 may be coupled to memory 432. Memory 432 may include an instruction such as compare instruction 102, which may be provided to prediction logic 104 and prediction history table 106, and this compare instruction 102 may be updated in memory 432 using updated prediction 115 as previously described in exemplary embodiments. FIG. 4 also shows display controller 426 that is coupled to DSP 464 and to display 428. Coder/decoder (CODEC) 434 (e.g., an audio and/or voice CODEC) can be coupled to DSP 464. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular embodiment, DSP 464, display controller 426, memory 432, CODEC 434, and wireless controller 440 are included in a system-in-package or system-on-chip device 422.

In a particular embodiment, input device 430 and power supply 444 are coupled to the system-on-chip device 422. Moreover, in a particular embodiment, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, DSP 464 and memory 432 may also be integrated into a set-top box, a music player, a video player, an entertainment unit, a navigation device, a personal digital assistant (PDA), a fixed location data unit, or a computer. A processor (e.g., DSP 464) may also be integrated into such a device.

Accordingly, an embodiment of the invention can include a computer readable media embodying a method for predicting evaluation of a producer instruction. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of predicting evaluation of a producer instruction comprising:
encoding a prediction field in the producer instruction; and
predicting evaluation of the producer instruction, in a processor, using prediction field.

2. The method of claim 1, wherein the producer instruction is a compare instruction.

3. The method of claim 1, wherein the prediction field comprises a bimodal prediction state.

4. The method of claim 1, wherein the bimodal prediction state is implemented as a two-bit saturating up-down counter.

5. The method of claim 1, further comprising:
executing the producer instruction to determine an actual evaluation of the producer instruction; and
updating the prediction field based on the actual evaluation and the predicted evaluation of the producer instruction.

6. The method of claim 5, further comprising storing the producer instruction with the updated prediction field in memory.

7. The method of claim 1, further comprising speculatively executing a consumer instruction predicated on the producer instruction, using the predicted evaluation of the producer instruction.

8. The method of claim 7, wherein the consumer instruction is a conditional branch instruction.

9. The method of claim 7, wherein one or more additional consumer instructions are predicated on the producer instruction.

10. The method of claim 1, wherein predicting evaluation of the producer instruction using the prediction field further comprises indexing a prediction history table with a function of the prediction field and a program counter value of the producer instruction.

11. The method of claim 10, wherein a value stored in the indexed location of the prediction history table comprises a prediction of evaluation of the producer instruction.

12. A processing system comprising:
a memory;
a producer instruction stored in the memory, the producer instruction comprising a prediction field;
and logic configured to predict evaluation of the producer instruction using the prediction field.

13. The processing system of claim 12, wherein the producer instruction is a compare instruction.

14. The processing system of claim 12, wherein the prediction field comprises a bimodal prediction state.

15. The processing system of claim 12, wherein the bimodal prediction state is configured as a two-bit saturating up-down counter.

16. The processing system of claim 12, wherein the logic configured to predict evaluation of the producer instruction using the prediction field comprises:
prediction logic configured to correlate a program counter or address of the producer instruction with the prediction field to generate an index value;
a prediction history table configured to store a history of behavior of prior producer instructions; and
indexing logic configured to access the prediction history table using the index value to obtain the predicted evaluation of the producer instruction.

17. The processing system of claim 16, wherein the behavior of prior producer instructions comprises predictions of prior producer instructions.

18. The processing system of claim 16, wherein the behavior of prior producer instructions comprises evaluations of prior producer instructions.

19. The processing system of claim 12, further comprising:
an execution pipeline configured to execute the producer instruction to determine an actual evaluation of the producer instruction; and
update logic configured to update the prediction field of the producer instruction based on the actual evaluation and the predicted evaluation of the producer instruction.

20. The processing system of claim 19, further comprising logic configured to store the producer instruction with the updated prediction field in the memory.

21. The processing system of claim 19, wherein the execution pipeline is further configured to speculatively execute a consumer instruction predicated on the producer instruction, using the predicted evaluation of the producer instruction.

22. The processing system of claim 21, wherein the consumer instruction is a conditional branch instruction.

23. The processing system of claim 21, wherein one or more additional consumer instructions are predicated on the producer instruction.

24. The processing system of claim 12 integrated in at least one semiconductor die.

25. The processing system of claim 12 integrated into a device selected from the group consisting of a set top box, music player, video player, entertainment unit, navigation device, communications device, personal digital assistant (PDA), fixed location data unit, and a computer.

26. A processing system comprising:
a producer instruction stored in a storage means, the producer instruction comprising a prediction field;
and means for predicting evaluation of the producer instruction using the prediction field.

27. The processing system of claim 26, wherein the producer instruction is a compare instruction.

28. The processing system of claim 26, wherein the means for predicting evaluation of the producer instruction comprises means for correlating a prediction history of prior producers instructions, the prediction field of the producer instruction, and an address of the producer instruction.

29. The processing system of claim 26, further comprising:
means for executing the producer instruction to determine an actual evaluation of the producer instruction; and
means for updating the prediction field of the producer instruction based on the actual evaluation and the predicted evaluation of the producer instruction.

30. The processing system of claim 26, further comprising means for storing the producer instruction with the updated prediction field in the storage means.

31. The processing system of claim 26, further comprising means for speculatively executing a consumer instruction predicated on the producer instruction, using the predicted evaluation of the producer instruction.

32. The processing system of claim 31, wherein the consumer instruction is a conditional branch instruction.

33. The processing system of claim 31, wherein one or more additional consumer instructions are predicated on the producer instruction.

34. A non-transitory computer-readable storage medium comprising code, which, when executed by a processor, causes the processor to perform operations for predicting evaluation of a producer instruction, the non-transitory computer-readable storage medium comprising:
code for encoding a prediction field in the producer instruction; and
code for predicting evaluation of the producer instruction, in a processor, using the prediction field.

35. The non-transitory computer-readable storage medium of claim 34, further comprising:
code for executing the producer instruction to determine an actual evaluation of the producer instruction;
code for updating the prediction field based on the actual evaluation and the predicted evaluation of the producer instruction; and
code for storing the producer instruction with the updated prediction field in memory.

36. The non-transitory computer-readable storage medium of claim 34, further comprising code for speculatively executing a consumer instruction predicated on the producer instruction, using the predicted evaluation of the producer instruction.
